(19) United States
(12) Patent Application Publication
(10) Pub. No.: US 2021/0291876 A1
(43) Pub. Date: Sep. 23, 2021

(54) MANAGEMENT DEVICE, DELIVERY SYSTEM, MANAGEMENT METHOD, AND PROGRAM

(71) Applicant: HONDA MOTOR CO., LTD., Tokyo (JP)

(72) Inventors: Yurie Kondo, Tokyo (JP); Kensaku Yamamoto, Wako-shi (JP); Koichi Ogura, Tokyo (JP); Ryohei Iwaki, Wako-shi (JP); Yusuke Kawada, Wako-shi (JP); Toshikatsu Kuramochi, Tokyo (JP)

(21) Appl. No.: 17/202,390

(22) Filed: Mar. 16, 2021

(30) Foreign Application Priority Data
Mar. 18, 2020 (JP) 2020-047101

(51) Int. Cl. B60W 60/00; G06K 9/00; G06Q 10/08; G06Q 10/02; B60W 30/18; H04W 4/40

(52) U.S. Cl. CPC B60W 60/00256; G06K 9/00791; H04W 4/40; G06Q 10/02; B60W 30/18018; G06Q 10/0833

(57) ABSTRACT

Provided is a management device for managing an operation of a package delivery vehicle including a storage of a package covered by an openable and closable door, which is configured to travel autonomously on a road without accommodating a driver, the management device including: a storage device that stores a program; and a hardware processor, in which the hardware processor is configured to execute the program stored in the storage device to: receive application information on delivery of the package from a user; and determine an operation of the package delivery vehicle based on at least the application information, in which the hardware processor is configured to cause the package delivery vehicle to stop on a road to load a package into the package delivery vehicle.

### CROSS-REFERENCE TO RELATED APPLICATION

Priority is claimed on Japanese Patent Application No. 2020-047101 filed on Mar. 18, 2020, the content of which is incorporated herein by reference.

### BACKGROUND

### Field of the Invention

The present invention relates to a management device, a delivery system, a management method, and a program.

### Description of Related Art

Japanese Patent Application Laid-open No. 2018-058656 discloses an invention relating to an unmanned delivery system configured to deliver a package by using an autonomous mobile machine that can move autonomously and a server system that operates in association with the autonomous mobile machine.

### SUMMARY

The above-mentioned related art loads a package into the autonomous mobile machine in a warehouse, and this configuration is not convenient sufficiently for a user.

The present invention has been made in view of the above-mentioned circumstances, and has an object to provide a management device, a delivery system, a management method, and a program, which are capable of improving the convenience.

A management device, a delivery system, management method, and a program according to this invention have the following configurations.

(1): A management device according to one aspect of the present invention is a management device for managing an operation of a package delivery vehicle including a storage of a package covered by an openable and closable door, which is configured to travel autonomously on a road without accommodating a driver, the management device including: a storage device that stores a program; and a hardware processor, in which the hardware processor is configured to execute the program stored in the storage device to: receive application information on delivery of the package from a user; and determine an operation of the package delivery vehicle based on at least the application information, in which the hardware processor is configured to cause the package delivery vehicle to stop on a road to load a package into the package delivery vehicle.

(2): In the aspect (1), the application information includes first specification information for specifying a loading position of the package, and the hardware processor is configured to cause, when the first specification information transmitted by a terminal device of the user has been acquired through communication, the package delivery vehicle to stop after the package delivery vehicle is caused to move to the loading position specified by the first specification information.

(3): In the aspect (1), the hardware processor is configured to provide position information of the package delivery vehicle to a terminal device of the user.

(4): In the aspect (1), the hardware processor is configured to select, based on the application information, a package delivery vehicle to be used for the user who has given the application information from among a plurality of package delivery vehicles.

(5): A delivery system according to another aspect of the present invention is a delivery system, including: the management device of the aspect 1; and the package delivery vehicle, in which the package delivery vehicle includes a recognition device configured to recognize an instruction to stop the package delivery vehicle given by the user, and in which the package delivery vehicle is configured to stop on a road when the recognition device has recognized a stop instruction given by the user.

(6): In the aspect (5), the package delivery vehicle includes an input device configured to receive input by the user, the application information includes second specification information for specifying an unloading position of a package, and the hardware processor is configured to cause the package delivery vehicle to move to the unloading position specified by the second specification information after loading of a package based on the second specification information input to the input device.

(7): In the aspect (5), the hardware processor is configured to transmit, when the hardware processor has received application information for reserving at least delivery of a package from the user, information for displaying a code image to the terminal device of the user who has made the reservation, in which the recognition device includes a camera configured to pick up an image of an outside of the package delivery vehicle, and in which the recognition device is configured to determine that an instruction to stop the package delivery vehicle given by the user is recognized when the camera has recognized the code image.

(8): In the aspect (5), the hardware processor is configured to transmit information for authenticating communication to the terminal device of the user who has made the reservation when the hardware processor has received application information for reserving at least delivery of a package from the user, the recognition device includes a communicator configured to communicate with the terminal device of the user, and the recognition device is configured to determine that an instruction to stop the package delivery vehicle given by the user is recognized when the communicator has received the information for authenticating communication from the terminal device.

(9): In the aspect (5), the package delivery vehicle includes a first storage that stores a package assigned with a label for identifying the package, which is distributed to the user in advance, and a second storage that stores a package not assigned with the label.

(10): In the aspect (5), the package delivery vehicle includes an issuance device configured to issue a label for identifying a package, which is assigned with a unique ID.

(11): In the aspect (9), the hardware processor is configured to assign a benefit to the user for the package assigned with the label.

(12): In the aspect (5), separate spaces for loading a plurality of packages are formed in the storage of the package delivery vehicle, and the hardware processor is configured to determine a space for loading a package in the package delivery vehicle in association with the application information given by the user, and transmit information on the association to a terminal device of a collection center.

(13): A management method according to another aspect of the present invention is a management method, which is executed by a management device for managing an operation of a package delivery vehicle including a storage of a package covered by an openable and closable door, which is configured to travel autonomously on a road without accommodating a driver, the management method including: receiving application information on delivery of the package from a user; determining an operation of the package delivery vehicle based on at least the application information; and causing the package delivery vehicle to stop on a road to load the package into the package delivery vehicle.

(14): A program according to another aspect of the present invention is a program for causing a computer of a management device for managing an operation of a package delivery vehicle including a storage of a package covered by an openable and closable door, which is configured to travel autonomously on a road without accommodating a driver, to: receive application information on delivery of the package from a user; determine an operation of the package delivery vehicle based on at least the application information; and cause the package delivery vehicle to stop on a road to load the package into the package delivery vehicle.

According to the aspects (1) to (14), it is possible to improve convenience.

### BRIEF DESCRIPTION OF THE DRAWINGS

FIG. 1 is a configuration diagram of a delivery system including a management device.

FIG. 2 is a configuration diagram of a package delivery vehicle.

FIG. 3 is a configuration diagram of the management device.

FIG. 4 is a diagram illustrating an example of details of user information.

FIG. 5 is a diagram illustrating an example of a delivery service application screen for inputting application information to be displayed on a display of a terminal device.

FIG. 6 is a diagram illustrating an example of details of an application information list.

FIG. 7 is a diagram conceptually illustrating details of movement schedule information.

FIG. 8 is a sequence diagram illustrating an example of a flow of processing for collecting a package, which is executed in a delivery system according to a first embodiment.

FIG. 9 is a diagram illustrating an example of structure of a storage.

FIG. 10 is a configuration diagram of a package delivery vehicle according to a second embodiment.

FIG. 11 is a diagram illustrating an example of a scene in which the package delivery vehicle is caused to stop in a second embodiment.

FIG. 12 is a sequence diagram illustrating an example of a flow of processing for collecting a package, which is executed in a delivery system according to a second embodiment.

### DESCRIPTION OF EMBODIMENTS

Now, description is given of a management device, a delivery system, a management method, and a program according to an embodiment of the present invention with reference to the drawings. The delivery system includes at least a management device and a package delivery vehicle. The package delivery vehicle can move autonomously on a road without accommodating a driver, and includes a storage of a package covered by an openable and closable door.

The package delivery vehicle recognizes the situation of the outside of the vehicle by a monitoring unit such as a camera, a radar device, and a LIDAR (Light Detection and Ranging) device, and travels along a path indicated by the management device in principle while at the same time avoiding an obstacle on the road. The wheels of the package delivery vehicle are driven by a motor, for example, and the package delivery vehicle moves on the road at a speed of about 10 [km]. In the storage of the package delivery vehicle, for example, a plurality of spaces for loading packages are formed so as to be separated from one another, and a plurality of users can load (carry) respective packages into those spaces.

The management device is configured to manage (control) operation of the package delivery vehicle. The management device may be a device that is placed at a location different from that of the package delivery vehicle, and communicates with the package delivery vehicle via a network or has a part or all of the functions included in the package delivery vehicle. The management device generates delivery schedule information based on application information acquired from a terminal device of a user through communication, for example. Then, the management device uses the delivery schedule information to notify the package delivery vehicle of, for example, a path, a stop location, and an open/close state of the door of the storage of the package delivery vehicle.

In the following description, it is assumed that the management device is a device (device in a mode referred to as cloud server, for example) placed at a location different from that of the package delivery vehicle, and implements the above-mentioned functions by communicating with the terminal device of the user or the package delivery vehicle via a network.

### First Embodiment

[Overall Configuration]

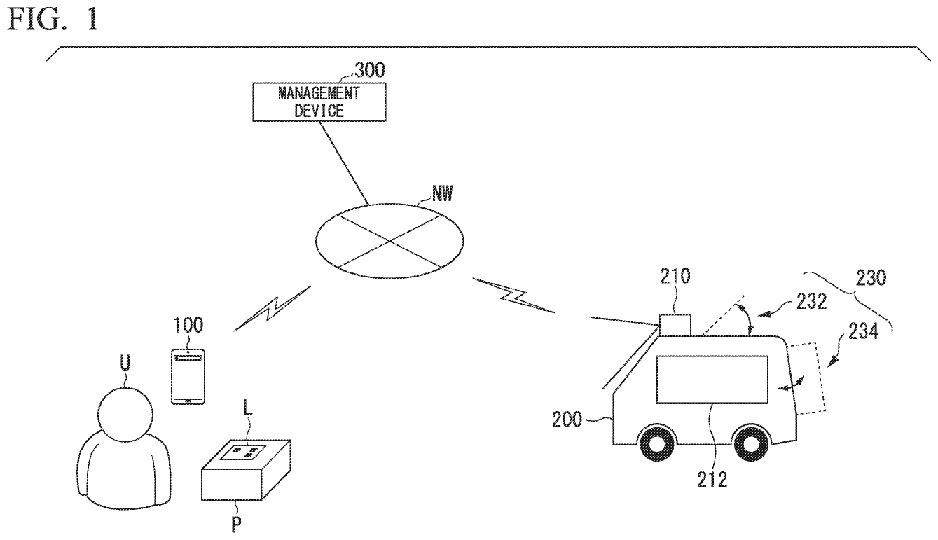

FIG. 1 is a configuration diagram of a delivery system 1 including a management device 300. The delivery system 1 includes one or more package delivery vehicles 200 and the management device 300. The management device 300 communicates with the terminal device 100 used by a user U via a network NW. The network NW includes, for example, the Internet, a wide area network (WAN), a local area network (LAN), a public line, a provider device, a dedicated line, or a wireless base station. Further, the management device 300 communicates with the package delivery vehicle 200 via the network NW. The “terminal device used by a user” refers to a terminal device that may be used by a large number of unspecified people, such as a terminal device of an Internet cafe, and may include a terminal device temporarily used by the user. In any case, the “terminal device of the user” refers to a terminal device for which a user performing operation is identified by a login operation of inputting a login name, for example.

The user U uses the terminal device 100 to transmit application information that requests delivery of a package P to the management device 300. Identification information of the package P and/or the user U is described on the package P, or a label L stored in, for example, an incorporated IC tag is assigned to the package P. The wording “assigned” means placing a sticker, for example.

The terminal device 100 is, for example, a smartphone, a tablet terminal, or a personal computer. An application program for using the above-mentioned service or a browser operates on the terminal device 100, and supports a service described below. In the following description, it is assumed that the terminal device 100 is a smartphone, and an application program (delivery service app) for receiving a service is operating. The delivery service app communicates with the management device 300 in response to an operation of the user, and transmits application information from the user to the management device 300 or provides information based on the information received from the management device 300. The application information refers to electronic information that requests delivery of the package P by the package delivery vehicle 200 along a specified section.

[Package Delivery Vehicle]

The package delivery vehicle 200 includes a monitoring unit 29 such as a camera, a radar device, and a LIDAR device, and travels autonomously on the road as described above. A display device 212 may be provided in the package delivery vehicle 200. The display device 212 may have a touch panel function, or may have an embedded function communicating with a non-contact IC card. Doors 230 including a top door 232 and a rear door 234 are provided in the package delivery vehicle 200, for example. The top door 232 is opened/closed with a vehicle width direction serving as a rotation axis, and at least a part of the storage 240 (described later) of the package delivery vehicle 200 is exposed under a state in which the top door 232 is opened. The rear door 234 is opened/closed in a mode of hinged double doors with a substantially vertical direction serving as a rotation axis, for example, and at least a part of the storage 240 (described later) of the package delivery vehicle 200 is exposed under a state in which the rear door 234 is opened.

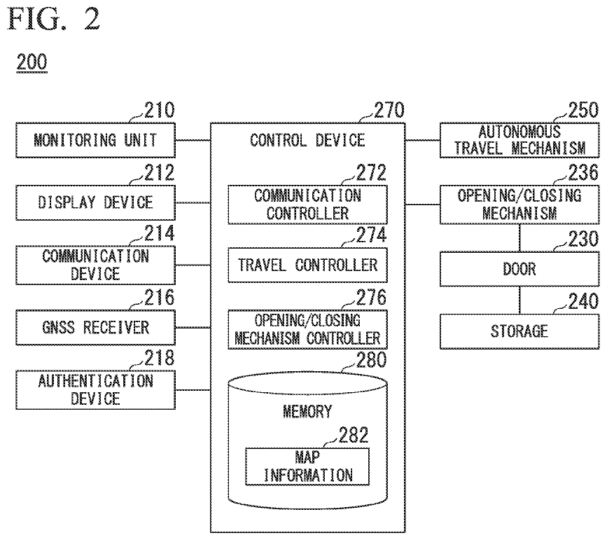

FIG. 2 is a configuration diagram of the package delivery vehicle 200. The package delivery vehicle 200 includes a communication device 214, a GNSS receiver 216, an authentication device 218, an opening/closing mechanism 236, an autonomous travel mechanism 250, and a control device 270 in addition to the monitoring unit 210, the display device 212, the doors 230, and the storage 240 described above.

The communication device 214 is, for example, a wireless communication module for connecting to the network NW, or directly communicating with, for example, another vehicle or a terminal device of a pedestrian. The communication device 214 performs wireless communication based on Wi-Fi, DSRC (Dedicated Short Range Communications), Bluetooth (registered trademark), or other communication standards. A plurality of communication devices may be prepared as the communication device 214 depending on the purpose.

The GNSS receiver 216 measures its position (position of package delivery vehicle 200) based on a radio wave received from a GNSS satellite (e.g., GPS satellite). The GNSS receiver 216 outputs the result of measurement to the control device 270.

The authentication device 218 is a device for checking whether a user who is trying to load the package P into the package delivery vehicle 200 is a valid user (authenticating user). The valid user herein refers to a user who has made arrangement (reservation) of delivery of a package with the management device 300. The authentication device 218 may be any device as long as the device has an authentication function such as a near-field communication device, a biometric authentication device, or a password input device. The authentication device 218 outputs a result of authentication to the control device 270.

The opening/closing mechanism 236 is provided for each door of the doors 230, and includes, for example, a motor and an arm. The opening/closing mechanism 236 individually opens/closes one of the doors 230. A switch that detects that the doors 230 are manually closed is mounted to the doors 230, for example.

The autonomous travel mechanism 250 includes, for example, a wheel, a drive power source such as a motor, energy storage means such as a battery, and a steering mechanism. The autonomous travel mechanism 250 causes the package delivery vehicle 200 to move in any direction in accordance with an instruction from the control device 270.

The control device 270 includes, for example, a communication controller 272, a travel controller 274, and an opening/closing mechanism controller 276. These components are implemented by a hardware processor such as a central processing unit (CPU) executing a program (software), for example. A part or all of these components may be implemented by hardware (circuit or circuitry) such as large scale integration (LSI), application specific integrated circuit (ASIC), field-programmable gate array (FPGA), or graphics processing unit (GPU), or may be implemented through cooperation between software and hardware. The program may be stored in a storage device (storage device including non-transitory storage medium) such as a hard disk drive (HDD) or a flash memory in advance, or may be stored in a removable storage medium (non-transitory storage medium) such as a DVD or a CD-ROM, and may be installed into the storage device by the storage medium being mounted to a drive device. The control device 270 includes a memory 280 storing map information 282. The memory 280 is, for example, an HDD, a flash memory, a ROM, or a random access memory (RAM).

The communication controller 272 acquires path information from the management device 300 via the communication device 214, and outputs the path information to the travel controller 274. The communication controller 272 uses the communication device 214 to upload position information indicating the position measured by the GNSS receiver 216 to the management device 300. The position information is uploaded periodically in units of millisecond to second, for example.

The travel controller 274 controls the autonomous travel mechanism 250 such that the package delivery vehicle 200 travels along a path specified by the management device 300. The travel controller 274 matches the path acquired from the management device 300 with the map information 282 and output of the monitoring unit 210, and determines a detailed path through which the package delivery vehicle 200 is to travel, for example. The travel controller 274 causes the package delivery vehicle 200 to travel autonomously so that the package delivery vehicle 200 travels on the path in principle while at the same time avoiding collision with an object (including guardrail or curb) for which the position and speed are input from the monitoring unit 210.

When the travel controller 274 has acquired a stop instruction from the management device 300, the travel controller 274 stops the package delivery vehicle 200. Instead, when the path information includes information of a stop position, the travel controller 274 may cause the package delivery vehicle 200 to stop when the result of measurement by the GNSS receiver 216 and the stop position match each other. In other words, the management device 300 gives a stop instruction or information of the stop position to the travel controller 274, and the travel controller 274 stops the package delivery vehicle 200 in accordance with the instruction or information. The position at which the package delivery vehicle 200 is caused to stop includes a road. In particular, when the user U loads the package P into the storage 240 of the package delivery vehicle 200, the package delivery vehicle 200 stops on the road or in a parking lot, for example.

The opening/closing mechanism controller 276 drives the opening/closing mechanism 236 at a timing indicated by the management device 300, for example.

[Management Device]

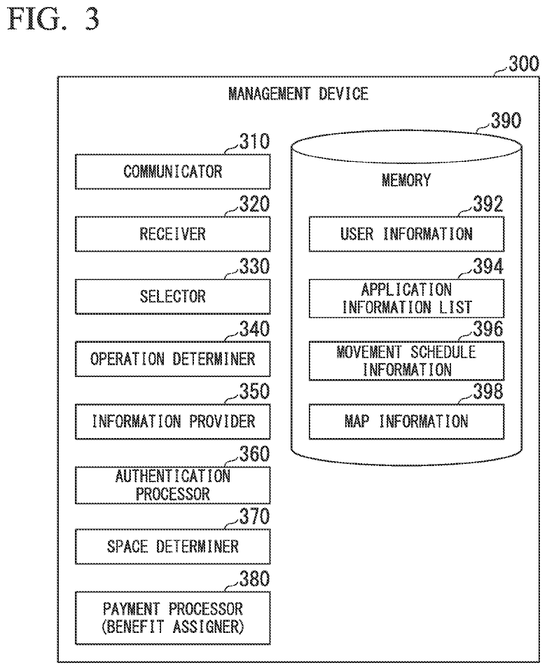

FIG. 3 is a configuration diagram of the management device 300. The management device 300 includes, for example, a communicator 310, a receiver 320, a selector 330, an operation determiner 340, an information provider 350, an authentication processor 360, a space determiner 370, and a payment processor 380. These components are implemented by a hardware processor such as a central processing unit (CPU) executing a program (software), for example. A part or all of these components may be implemented by hardware (circuit or circuitry) such as LSI, ASIC, FPGA, or GPU, or may be implemented through cooperation between software and hardware. The program may be stored in a storage device (storage device including non-transitory storage medium) such as a hard disk drive (HDD) or a flash memory in advance, or may be stored in a removable storage medium (non-transitory storage medium) such as a DVD or a CD-ROM, and may be installed into the storage device by the storage medium being mounted to a drive device. The management device 300 may include a memory 390. The memory 390 is implemented by, for example, a DVD, a random access memory (RAM), or a flash memory. The memory 390 stores information such as the user information 392, an application information list 394, movement schedule information 396, and map information 398.

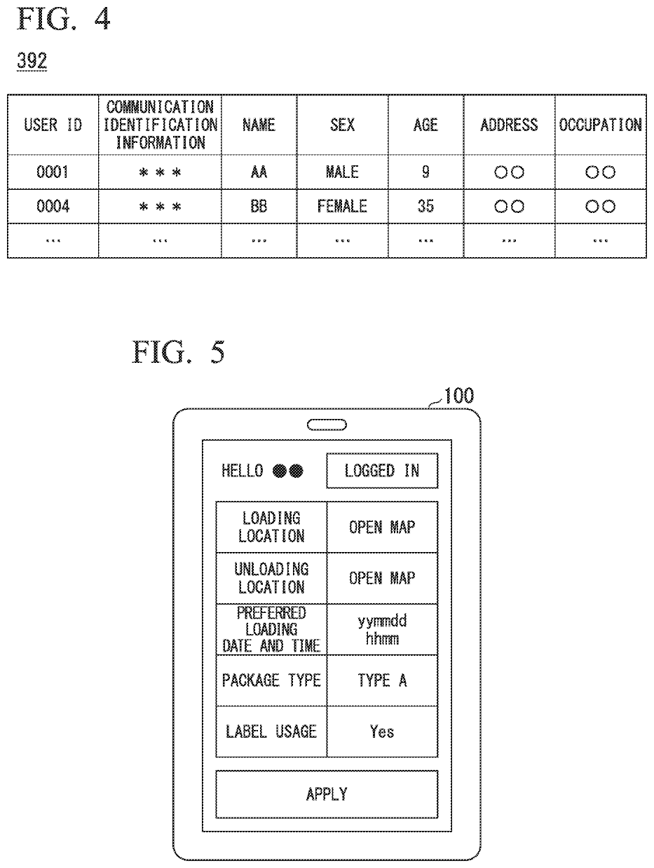

FIG. 4 is a diagram illustrating an example of details of the user information 392. The user information 392 associates, for example, a user ID being identification information of a user with information such as communication identification information, name, sex, age, address, and occupation. Each item of the user information 392 is registered in advance at the time of application for a service that is managed by the management device 300, for example. The communication identification information is information necessary for transmitting information to the terminal device 100, and is information such as an app ID assigned to the application program, an IP (Internet Protocol) address, a MAC (Media Access Control) address, and an e-mail address.

The communicator 310 is a network card for connecting to the network NW, for example. The communicator 310 communicates with the terminal device 100 or the package delivery vehicle 200 via the network NW.

The receiver 320 acquires (receives) application information issued from the terminal device 100 of the user via the communicator 310, and adds the application information to the application information list 394. FIG. 5 is a diagram illustrating an example of a delivery service application screen for inputting application information to be displayed on a display of the terminal device 100. As illustrated in FIG. 5, a loading location (first specification information), an unloading location (second specification information), a preferred loading time, a package type indicating the size or shape of a package, and whether to use a label indicating whether a defined label is to be used can be input on the delivery service application screen, and information input by the user U is transmitted to the management device 300 as the application information. The loading location or unloading location is input by, for example, the terminal device 100 displaying a map and the user U specifying a location on the map. The defined label is given to the user U by an administrator of a delivery service 1 in advance, for example, and a unique identification number (unique ID) is assigned for each label. When the defined label is used, the user U inputs a unique identification number described in the label, or an identification number unique to a label is input via a barcode reader of the terminal device 100. The terminal device 100 transmits the identification number unique to a label acquired in this manner to the management device 300. The receiver 320 also adds this information to the application information list 394.

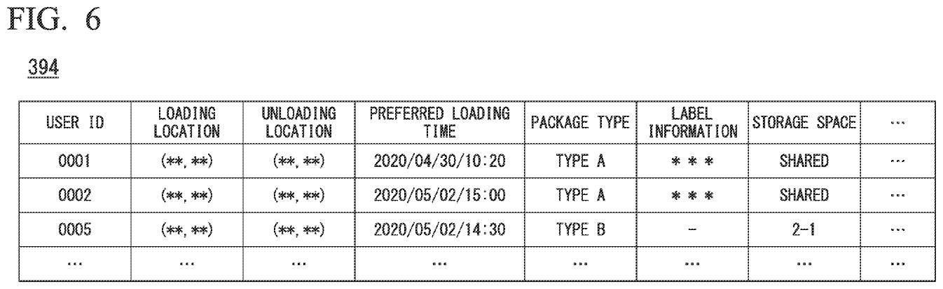

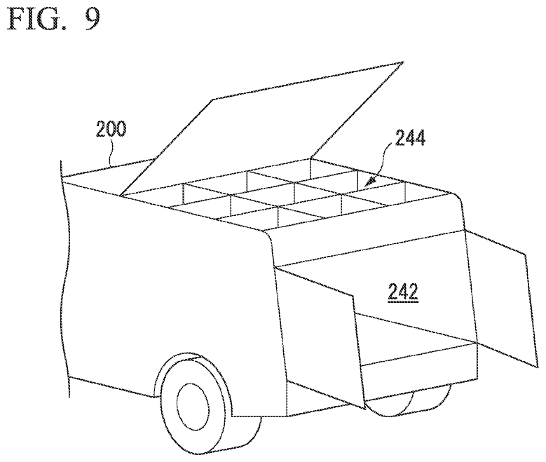

FIG. 6 is a diagram illustrating an example of details of the application information list 394. The application information list 394 is information that associates, for example, a user ID of a user who has given the application information, a loading location serving as a start point of a section relating to delivery of a package, an unloading location serving as an end point of the section, a preferred loading time, a package type, an identification number (label information) unique to a label, and a storage space with one another. One set of the user ID, the loading location, the unloading location, the preferred loading time, the package type, the label information, and the storage space relating to one piece of application information are hereinafter referred to as “record”. The application information is information in any format, including details necessary for generating one record. The meaning of the storage space is described with reference to FIG. 9.

When a record of new application information is added to the application information list 394, the selector 330 refers to a list (not shown) of the package delivery vehicles 200 and the movement schedule information 396, and selects the package delivery vehicle 200 to be used by the user relating to the application information from among the plurality of package delivery vehicles 200. For example, the selector 330 refers to the package type included in the application information to narrow down to the package delivery vehicle 200 capable of delivering the package P, and then when it is appropriate to incorporate collection of the package P into an existing movement schedule of the package delivery vehicle 200 already incorporated in the movement schedule information 396, the selector 330 adds collection of the package P to the existing movement schedule, or otherwise, the selector 330 sets a new movement schedule of the package delivery vehicle 200 and registers collection of the package P.

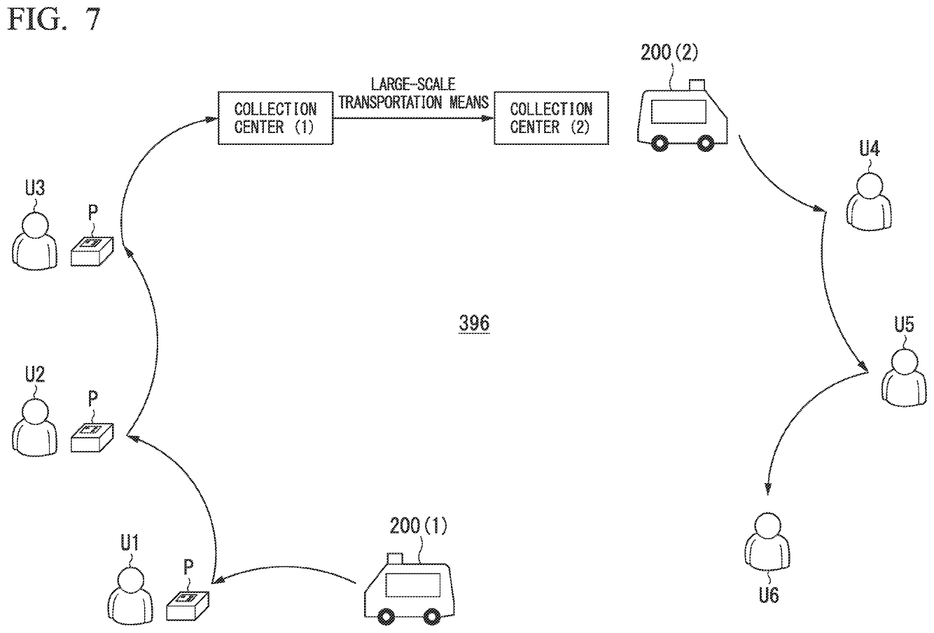

FIG. 7 is a diagram conceptually illustrating details of the movement schedule information 396. As illustrated in FIG. 7, the movement schedule information 396 includes information defining such a series of operations that a certain package delivery vehicle 200(1) collects the package P of the user U1 at the loading location and preferred loading time of the user U1, next collects the package P of the user U2 at the loading location and preferred loading time of the user U2, next collects the package P of the user U3 at the loading location and preferred loading time of the user U3, and then delivers the packages P to a collection center (1). In the collection center, the collected packages P are sorted by region of the delivery destination, and then an operation of delivering the collected packages P to another collection center is performed. Large-scale transportation means such as a large truck or a railway is used to deliver the package P between collection centers (between collection center (1) and collection center (2) in FIG. 7). The movement schedule information 396 may further include information defining an operation of delivering the package P from the collection center (2) to users U4, U5, and U6 in the stated order. Regarding delivery past the collection center, for example, label information obtained from a label may be used as a key to search for the application information list 394 and information of the delivery destination (unloading location) is acquired, and thus an operation of the package delivery vehicle 200(2) is determined based on the information. The present invention mainly focuses on the operation at the time of collection of the package, and thus further details relating to delivery are omitted.

The operation determiner 340 generates the movement schedule information 396 as described above. For example, the operation determiner 340 roughly groups records of the application information by date, time slot, and region, sets several movement patterns in which a plurality of loading locations and preferred loading times are arranged in order, extracts a movement pattern having the lowest movement cost by referring to the map information 398, and adds the extracted movement pattern to the movement schedule information 396. Various techniques of calculating and evaluating a movement cost are publicly known in the field of a navigation system, and thus description thereof is omitted here.

Then, the operation determiner 340 uses the communicator 310 to transmit an operation instruction to the package delivery vehicle 200 in accordance with details described in the movement schedule information 396. In other words, the operation determiner 340 determines the operation of the package delivery vehicle 200 based on the movement schedule information 396 generated based on the application information received by the receiver 320. The operation determiner 340 uses the communicator 310 to transmit, to the package delivery vehicle 200, an operation instruction for stopping the package delivery vehicle 200 on the road in order to load the package P into the package delivery vehicle 200. As described above, such an instruction method includes a method of transmitting a stop instruction and a method of transmitting a stop position.

The information provider 350 provides the terminal device 100 of the user U with the position information of the package delivery vehicle 200. The information provider 350 uses the communicator 310 to transmit, to the terminal device 100, position information uploaded by the communication controller 272 of the package delivery vehicle 200 through use of the communication device 214. The information provider 350 transmits, to the terminal device 100, information for overlapping an image indicating position information with the map information and displaying the image.

The authentication processor 360 acquires various kinds of information (e.g., password, biometric information, and token) acquired by the authentication device 218 of the package delivery vehicle 200, for example, and when the acquired information is valid, the authentication processor 360 notifies the operation determiner 340 of information indicating that authentication is successful. In response to this, the operation determiner 340 transmits information instructing the package delivery vehicle 200 to open one of the doors 230. In the package delivery vehicle 200, the opening/closing mechanism controller 276 drives the opening/closing mechanism 236 so as to open a specified one of the doors 230. After the user U stores the package P into the storage 240, the user U manually closes the specified one of the doors 230, for example. The package delivery vehicle 200 starts to move to the next loading location, for example, based on information from a switch mounted to the doors 230. In this manner, delivery of the package P is complete.

The function of the space determiner 370 is described with reference to FIG. 9. The payment processor 380 executes processing for collecting a charge from the user U. The payment processor 380 is an example of “benefit assigner”. For example, the payment processor 380 collects a charge from the user U in cooperation with a management server of a credit card or electronic money. The payment processor 380 assigns a benefit to the user U by discounting a current charge or giving a coupon for next usage for the user U who has used a defined label.

[Processing Sequence]

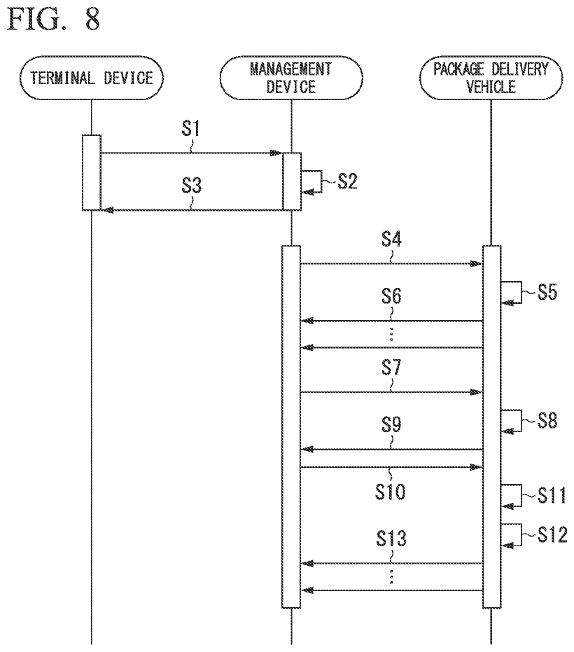

FIG. 8 is a sequence diagram illustrating an example of a flow of processing for collecting a package, which is executed in the delivery system 1 according to the first embodiment. First, the terminal device 100 transmit application information to the management device 300 (Step S1). The management device 300 adds the application information to the application information list 394 to update the movement schedule information 396 (Step S2). The management device 300 transmits a notification of receiving the application information to the terminal device 100 (Step S3).

Next, when the timing of starting the package delivery vehicle 200 has arrived, the management device 300 transmits a path and a start instruction to the package delivery vehicle 200 (Step S4). The package delivery vehicle 200 autonomously travels along the path (Step S5). The package delivery vehicle 200 periodically uploads own position information to the management device 300 (Step S6).

When the package delivery vehicle 200 has arrived at a loading position, the management device 300 transmits a stop instruction to the package delivery vehicle 200 (Step S7). Now, it is assumed that a stop instruction is given by such a technique. The package delivery vehicle 200 stops on a road in response to the stop instruction (Step S8). The package delivery vehicle 200 transmits various kinds of information acquired by the monitoring unit 210 to the management device 300 (Step S9). When the information acquired (received) in Step S9 is valid, the management device 300 transmits, to the package delivery vehicle 200, information indicating an instruction to open one of the doors 230 (Step S10).

The package delivery vehicle 200 drives the opening/closing mechanism 236 so as to open the specified one of the doors 230 (Step S11), and when the user U has closed the doors, the package delivery vehicle 200 starts to move to the next loading location or collection center (Step S12). Then, the package delivery vehicle 200 periodically uploads the own position information to the management device 300 again (Step S13).

[Storage]

Now, the storage 240 of the package delivery vehicle 200 is described more in detail. FIG. 9 is a diagram illustrating an example of structure of the storage 240. The storage 240 of the package delivery vehicle 200 includes a first storage 242 that stores the package P assigned with a label, and a second storage 244 that stores a package not assigned with a label. The first storage 242 is a shared storage in which the package P may be loaded anywhere. The second storage 244 is a storage in which a plurality of spaces for storage, which are separated from one another, are formed. One space of the second storage 244 stores only one package P (or package P of one user U). The owner of the package P stored in the second storage 244 is recognized based on in which space of a collection center, the package P is stored. The owner of the package P stored in the storage 240 is recognized based on which storage 240 stores the package P in a collection center, for example. Then, for example, a worker of the collection center assigns a label to the package P, to thereby be able to identify a delivery destination (unloading location) in subsequent work.

When the receiver 320 has received application information (refer to FIG. 5) from the user U who does not use a label, the space determiner 370 of the management device 300 determines a space of the package delivery vehicle 200 in which a package is to be loaded in association with a record of the application information, and adds information indicating the space to the application information list 394, and returns the information to the terminal device 100 (processing of Step S3 of FIG. 8). Referring to FIG. 6 again, the information to be added to the application information list 394 is “storage space”. In contrast, “shared”, namely, information indicating storage in the first storage 242 is registered in an item of “storage space” in the record of the application information given by the user U who uses a label.

Then, the space determiner 370 transmits association information to a terminal device X (not shown) of the collection center. The association information is, for example, information associating a user ID with information of “storage space”. When a worker of the collection center has found a relevant package P, the worker assigns a label to the package P, and inputs, to the terminal device X, information associating label information of the label with the user ID. The input information is transmitted to the management device 300, and is added to the application information list 394. Thus, in the subsequent processing, the package is treated in the same manner as the package P assigned with a label initially.

In the above description, the defined label is distributed to the user U in advance. Instead (or in addition), an issuance device that issues a label for identifying a package, which is assigned with a unique ID, may be installed in the package delivery vehicle 200. In this case, the user U who has received a label and assigned the label to the package P inputs a unique identification number described in the label to the terminal device 100, or uses a barcode reader of the terminal device 100 to read an identification number unique to the label. Also in this case, the terminal device 100 similarly transmits an identification number to the management device 300.

The package delivery vehicle 200 may include only a plurality of spaces separated similarly to the second storage 244 without including a shared space. In that case, the storage location of the package P is specified for all the users U.

According to the first embodiment described above, it is possible to improve convenience.

### Second Embodiment

Now, a second embodiment is described. The second embodiment is different from the first embodiment in a phenomenon that triggers autonomous stop of the package delivery vehicle. In the following, description is given with focus on this difference.

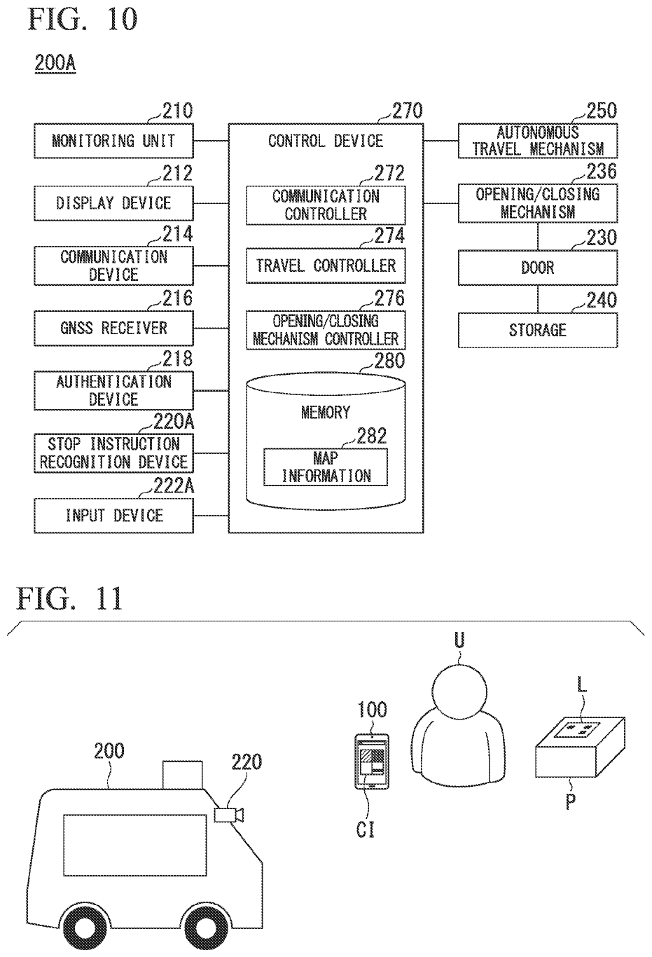

FIG. 10 is a configuration diagram of a package delivery vehicle 200A according to a second embodiment. The package delivery vehicle 200A includes a stop instruction recognition device 220A and an input device 222A. The stop instruction recognition device 220A recognizes a stop instruction given by the user U. When the stop instruction recognition device 220A has recognized a stop instruction, the stop instruction recognition device 220A outputs information indicating recognition of the stop instruction to the control device 270. When the travel controller 274 of the control device 270 has acquired the information indicating recognition of the stop instruction, the travel controller 274 instructs the autonomous travel mechanism 250 to cause the package delivery vehicle 200A to stop on the road. In this case, the travel controller 274 serves as “operation determiner”. Instead, when the stop instruction recognition device 220A has recognized a stop instruction, the stop instruction recognition device 220A may use the communication device 214 to transmit the information indicating recognition to the management device 300A (reference symbol A is assigned to component specific to second embodiment for description, which is not shown), and the operation determiner 340 of the management device 300A may transmit information indicating a stop instruction to the package delivery vehicle 200A. In any case, a stop instruction of the user U is recognized, and thus information indicating that the package delivery vehicle 200A is stopped is transmitted to the management device 300A.

When the receiver 320 has received application information, the authentication processor 360A of the management device 300A transmits information for displaying a code image to the terminal device 100 that has transmitted the application information. In the second embodiment, the amount of application information may be smaller than that of the first embodiment, and for example, information of the desired date and time of loading may be omitted. Information for identifying a record of the application information is encoded in the code image, for example.

FIG. 11 is a diagram illustrating an example of a scene in which the package delivery vehicle 200A is caused to stop in the second embodiment. After the above-mentioned processing is performed, the user U operates the delivery service app to display a code image CI on the terminal device 100, and directs the code image CI toward the package delivery vehicle 200A when the package delivery vehicle 200A has travelled near the user U. The stop instruction recognition device 220A of the package delivery vehicle 200A includes a camera and an image analysis device. The camera picks up the code image CI, and the image analysis device recognizes details encoded in the code image CI by image analysis, and when the recognized details are valid information, the package delivery vehicle 200A determines that a stop instruction is recognized.

Furthermore, in the second embodiment, the user U may use the input device 222A to input information such as the unloading location or package type. The input device 222A is an input device such as a touch panel. The information input to the input device 222A is transmitted to the management device 300 by the communication device 214, and is handled as a part of the application information. In the second embodiment, the stop instruction recognition device 220A or the input device 222A may share a function with a part or all of the monitoring unit 210 and the authentication device 218.

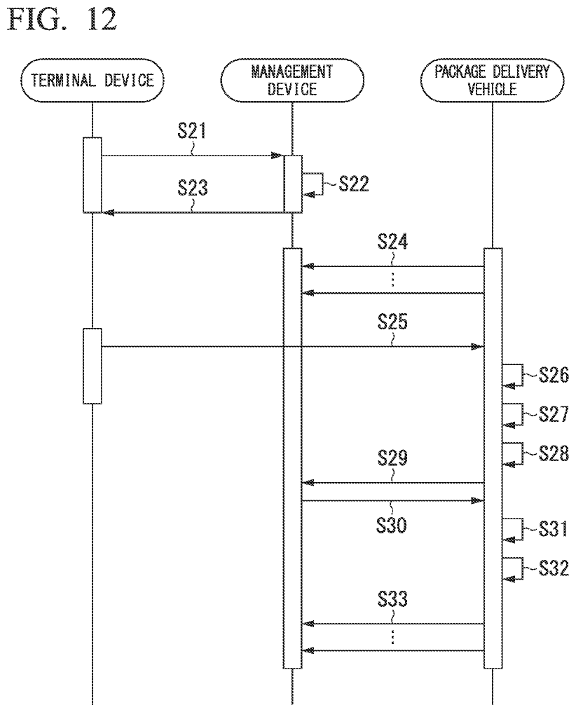

FIG. 12 is a sequence diagram illustrating an example of a flow of processing for collecting a package, which is executed in the delivery system 1A according to the second embodiment. First, the terminal device 100 transmits application information to the management device 300 (Step S21). The management device 300 adds the application information to the application information list 394, and updates the movement schedule information 396 (Step S22). The management device 300 transmits, to the terminal device 100, a notification of receiving the application information and information for displaying a code image (Step S23).

The autonomously traveling package delivery vehicle 200 periodically uploads own position information to the management device 300 (Step S24).

When the user U has caused the terminal device 100 to display the code image CI and has directed the code image CI toward the nearby package delivery vehicle 200A (Step S25), the stop instruction recognition device 220A recognizes the code image CI, and determines whether the encoded information is valid information (Step S26). When it is determined that the encoded information is valid information, the stop instruction recognition device 220A outputs information to that effect to the control device 270 (Step S27), and the control device 270 stops the package delivery vehicle 200A (Step S28).

The package delivery vehicle 200A transmits information indicating that the package delivery vehicle 200A is stopped and information read from the code image CI to the management device 300 (Step S29). The management device 300 transmits, to the package delivery vehicle 200, information indicating one of the doors 230 to be opened (Step S30). In the second embodiment, when it is determined that the information encoded in the code image CI is valid information, the processing of opening one of the doors 230 may be executed by the package delivery vehicle 200A after the package delivery vehicle 200A is stopped.

The package delivery vehicle 200A drives the opening/closing mechanism 236 so as to open the specified one of the doors 230 (Step S31), and when the user U has closed the doors 230, the package delivery vehicle 200 starts to move to the next loading location or collection center (Step S32). Then, the package delivery vehicle 200 periodically uploads the own position information to the management device 300 again (Step S33).

According to the second embodiment described above, the user U can easily cause the nearby package delivery vehicle 200A on the road to stop, and thus it is possible to improve convenience further while at the same time obtaining an effect similar to that of the first embodiment.

### Third Embodiment

Now, a third embodiment is described. The third embodiment is different from the second embodiment in a technique of recognizing a stop instruction. In the following, description is given with focus on this difference.

The configuration of the second embodiment illustrated in FIG. 10 is adopted. Although not shown, a component specific to the third embodiment is assigned with a reference symbol B for description. Similarly to the second embodiment, a stop instruction recognition device 220B recognizes a stop instruction given by the user U. When the stop instruction recognition device 220B has recognized a stop instruction, the stop instruction recognition device 220B outputs information indicating recognition of the stop instruction to the control device 270. When the travel controller 274 of the control device 270 has acquired the information indicating recognition of the stop instruction, the travel controller 274 instructs the autonomous travel mechanism 250 to cause the package delivery vehicle 200A to stop on the road. Instead, when the stop instruction recognition device 220B has recognized a stop instruction, the stop instruction recognition device 220B may use the communication device 214 to transmit the information indicating recognition to the management device 300B, and the operation determiner 340 of the management device 300B may transmit information indicating a stop instruction to the package delivery vehicle 200B. In any case, a stop instruction of the user U is recognized, and thus information indicating that the package delivery vehicle 200B is stopped is transmitted to the management device 300B.

When the receiver 320 has received application information, the authentication processor 360B of the management device 300B transmits information for authenticating communication to the terminal device 100 that has transmitted the application information. In the third embodiment, the amount of application information may be smaller than that of the first embodiment, and for example, information of the desired date and time of loading may be omitted. Information for authenticating communication includes, for example, information for identifying a record of the application information.

After the above-mentioned processing is performed, when the package delivery vehicle 200B has travelled near the user U, the user U operates the delivery service app to cause the terminal device 100 to transmit information for authenticating communication. The stop instruction recognition device 220B of the package delivery vehicle 200B includes a communication device, and determines that a stop instruction is recognized when the information received by the communication device is valid information.

Furthermore, in the third embodiment, the user U may use the input device 222B to input information such as the unloading location or package type. The input device 222B is an input device such as a touch panel. The information input to the input device 222B is transmitted to the management device 300 by the communication device 214, and is handled as a part of the application information. In the third embodiment, the stop instruction recognition device 220B or the input device 222B may share a function with a part or all of the communication device 214 and the authentication device 218.

When a sequence diagram of the third embodiment is compared with that of the second embodiment, the sequence diagram of the third embodiment is obtained by replacing presentation of a code image and communication, and thus description of the sequence diagram is omitted here.

According to the third embodiment described above, the user U can easily cause the nearby package delivery vehicle 200A on the road to stop, and thus it is possible to improve convenience further while at the same time obtaining an effect similar to that of the first embodiment.

The embodiments described above can be represented in the following manner.

A management device for managing an operation of a package delivery vehicle including a storage of a package covered by an openable and closable door, which is configured to travel autonomously on a road without accommodating a driver, the management device including:

a storage device storing a program; and

a hardware processor,

in which the hardware processor is configured to execute the program to:

receive application information on delivery of the package from a user;

determine an operation of the package delivery vehicle based on at least the application information; and

cause the package delivery vehicle to stop on a road to load the package into the package delivery vehicle.

In the above, modes for carrying out the present invention have been described by way of embodiments. However, the present invention is not limited to such embodiments in any manner, and various kinds of modifications and replacements can be made within the scope that does not depart from the gist of the present invention.

What is claimed is:

1. A management device for managing an operation of a package delivery vehicle including a storage of a package covered by an openable and closable door, which is configured to travel autonomously on a road without accommodating a driver, the management device comprising:
a storage device that stores a program; and
a hardware processor,
wherein the hardware processor is configured to execute the program stored in the storage device to:
receive application information on delivery of the package from a user; and
determine an operation of the package delivery vehicle based on at least the application information,
wherein the hardware processor is configured to cause the package delivery vehicle to stop on a road to load a package into the package delivery vehicle.

2. The management device according to claim 1,
wherein the application information includes first specification information for specifying a loading position of the package, and
wherein the hardware processor is configured to cause, when the first specification information transmitted by a terminal device of the user has been acquired through communication, the package delivery vehicle to stop after the package delivery vehicle is caused to move to the loading position specified by the first specification information.

3. The management device according to claim 1, wherein the hardware processor is configured to provide position information of the package delivery vehicle to a terminal device of the user.

4. The management device according to claim 1, wherein the hardware processor is configured to select, based on the application information, a package delivery vehicle to be used for the user who has given the application information from among a plurality of package delivery vehicles.

5. A delivery system, comprising:
the management device of claim 1; and
the package delivery vehicle,
wherein the package delivery vehicle includes a recognition device configured to recognize an instruction to stop the package delivery vehicle given by the user, and
wherein the package delivery vehicle is configured to stop on a road when the recognition device has recognized a stop instruction given by the user.

6. The delivery system according to claim 5,
wherein the package delivery vehicle includes an input device configured to receive input by the user,
wherein the application information includes second specification information for specifying an unloading position of a package, and
wherein the hardware processor is configured to cause the package delivery vehicle to move to the unloading position specified by the second specification information after loading of a package based on the second specification information input to the input device.

7. The delivery system according to claim 5,
wherein the hardware processor is configured to transmit, when the hardware processor has received application information for reserving at least delivery of a package from the user, information for displaying a code image to the terminal device of the user who has made the reservation,
wherein the recognition device includes a camera configured to pick up an image of an outside of the package delivery vehicle, and
wherein the recognition device is configured to determine that an instruction to stop the package delivery vehicle given by the user is recognized when the camera has recognized the code image.

8. The delivery system according to any one of claim 5,
wherein the hardware processor is configured to transmit information for authenticating communication to the terminal device of the user who has made the reservation when the hardware processor has received application information for reserving at least delivery of a package from the user,
wherein the recognition device includes a communicator configured to communicate with the terminal device of the user, and
wherein the recognition device is configured to determine that an instruction to stop the package delivery vehicle given by the user is recognized when the communicator has received the information for authenticating communication from the terminal device.

9. The delivery system according to claim 5, wherein the package delivery vehicle includes a first storage that stores a package assigned with a label for identifying the package, which is distributed to the user in advance, and a second storage that stores a package not assigned with the label.

10. The delivery system according to claim 5, wherein the package delivery vehicle includes an issuance device configured to issue a label for identifying a package, which is assigned with a unique ID.

11. The delivery system according to claim 9, wherein the hardware processor is configured to assign a benefit to the user for the package assigned with the label.

12. The delivery system according to claim 5,
wherein separate spaces for loading a plurality of packages are formed in the storage of the package delivery vehicle, and
wherein the hardware processor is configured to determine a space for loading a package in the package delivery vehicle in association with the application information given by the user, and transmit information on the association to a terminal device of a collection center.

13. A management method, which is executed by a management device for managing an operation of a package delivery vehicle including a storage of a package covered by an openable and closable door, which is configured to travel autonomously on a road without accommodating a driver, the management method comprising:
receiving application information on delivery of the package from a user;
determining an operation of the package delivery vehicle based on at least the application information; and
causing the package delivery vehicle to stop on a road to load the package into the package delivery vehicle.

14. A program for causing a computer of a management device for managing an operation of a package delivery vehicle including a storage of a package covered by an openable and closable door, which is configured to travel autonomously on a road without accommodating a driver, to:
receive application information on delivery of the package from a user;
determine an operation of the package delivery vehicle based on at least the application information; and
cause the package delivery vehicle to stop on a road to load the package into the package delivery vehicle.
